(19) United States
(12) Patent Application Publication
(10) Pub. No.: US 2013/0337989 A1
(43) Pub. Date: Dec. 19, 2013

(54) APPARATUS AND METHOD FOR ALIGNING AND TRANSPORTING PRINTED PRODUCTS

(71) Applicant: Goss International Americas Inc., Durham, NH (US)

(72) Inventor: Thomas Bowen Clarke, Durham, NH (US)

(21) Appl. No.: 13/898,614

(22) Filed: May 21, 2013

Related U.S. Application Data
(60) Provisional application No. 61/659,094, filed on Jun. 13, 2012.

(51) Int. Cl. B41F 21/00; B65H 45/00; B65H 5/26

(52) U.S. Cl. CPC B41F 21/00; B65H 5/26; B65H 45/00
USPC 493/324; 271/225; 493/405

(57) ABSTRACT

An alignment and transport apparatus is provided including an input conveyor transporting and positioning successive sheets in a first plane in a first direction and a twisting apparatus defining a transport path for the successive sheets. The twisting apparatus is configured such that each of the sheets enters the transport path in the first plane and traveling in the first direction with a first side of each of the sheets facing upward and such that each of the sheets exits the transport path in a second plane and traveling in a second direction with a second side of each of the sheets facing upward. A variable data sheet insertion device, a post-press processing apparatus and a method for aligning and transporting printed products are also provided.

This application claims priority to U.S. Provisional Application Ser. No. 61/659,094, filed Jun. 13, 2012, the entire disclosure of which is hereby incorporated by reference.

The present invention relates generally to post-press equipment for printing and more specifically to a method and apparatus for aligning and transporting printed products into a post-press line.

### BACKGROUND OF INVENTION

U.S. Pat. No. 7,775,509 discloses a method for producing a digitally printed product that includes at least one section of sequentially printed sheets folded approximately in the center. The sequentially printed sheets are folded to form a first fold and conveyed one after another on a conveying device. The folded sheets are gathered into sections in a gathering station and fed to a work station for folding approximately in the center to form a second fold.

### BRIEF SUMMARY OF THE INVENTION

An alignment and transport apparatus is provided including an input conveyor transporting successive sheets in a first plane in a first direction and a twisting apparatus defining a transport path for the successive sheets. The twisting apparatus is configured such that each of the sheets enters the transport path in the first plane and traveling in the first direction with a first side of each of the sheets facing upward and such that each of the sheets exits the transport path in a second plane and traveling in a second direction with a second side of each of the sheets facing upward.

A variable data sheet insertion device is also provided. The variable data sheet insertion device includes a printing station printing varying images on a web, a cutting device cutting the web into successive varying sheets and an alignment and transport apparatus downstream of the cutting device receiving the successive varying sheets and realigning the successive varying sheets. The alignment and transport apparatus receives the successive varying sheets traveling in a first direction with a first side of each sheet facing upward and outputs the successive varying sheets in a second direction with a second side of each sheet facing upward.

A method for aligning and transporting printed products is also provided. The method includes receiving a printed product traveling along a first plane in a first direction at an input of a transport path, the printed product being aligned during the receiving such that a first side of the printed product faces upward and a first edge of the printed product is aligned perpendicular to first direction, continuously moving the printed product along the transport path such that the printed product is realigned and outputting the printed product from an end of the transport path along a second plane in a second direction, the printed product being aligned during the outputting such that a second side of the printed product faces upward and the first edge of the printed product is aligned perpendicular to the second direction.

### BRIEF DESCRIPTION OF THE DRAWINGS

The present invention is described below by reference to the following drawings, in which:

FIG. 1 schematically shows a plan view of a variable data sheet insertion device according to an embodiment of the present invention included in a post-press line;

FIG. 2a schematically shows a plan view of an alignment and transport apparatus of the variable data sheet insertion device according to an embodiment of the present invention; and

FIG. 2b schematically shows a side view of the alignment and transport apparatus shown in FIG. 2a.

### DETAILED DESCRIPTION

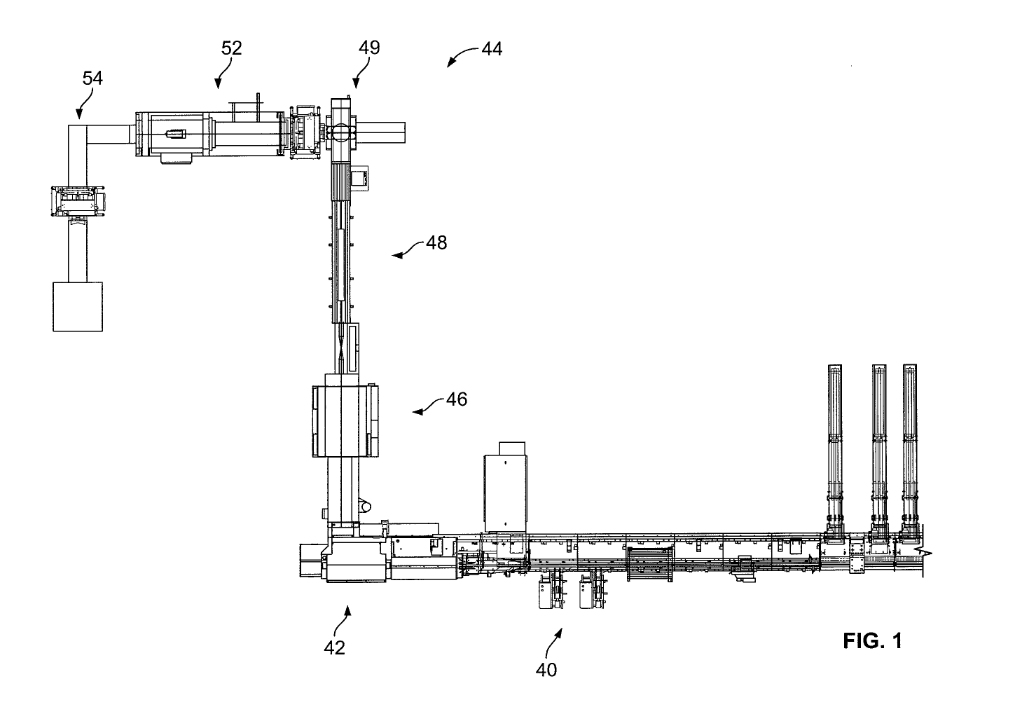

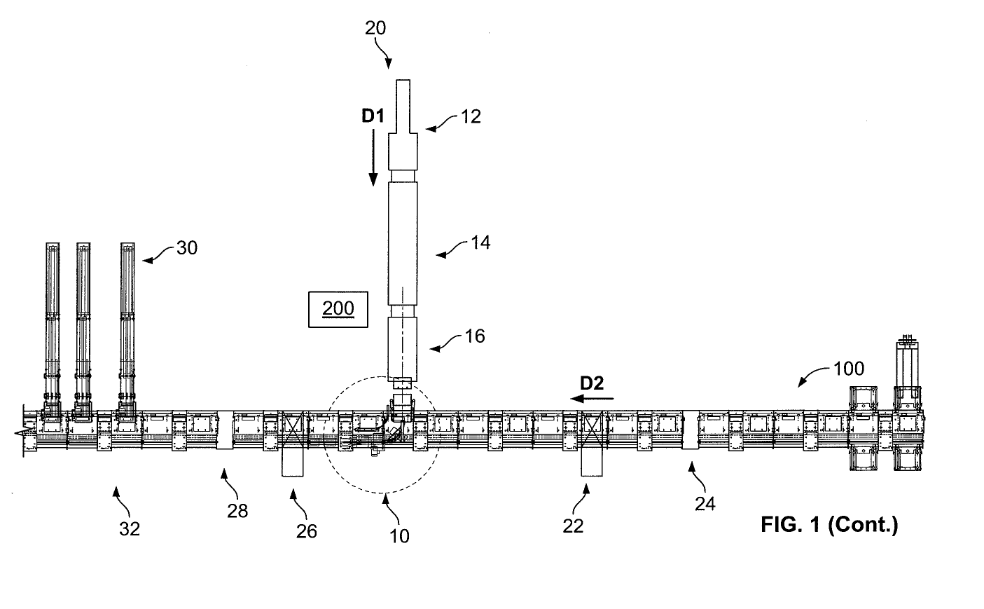

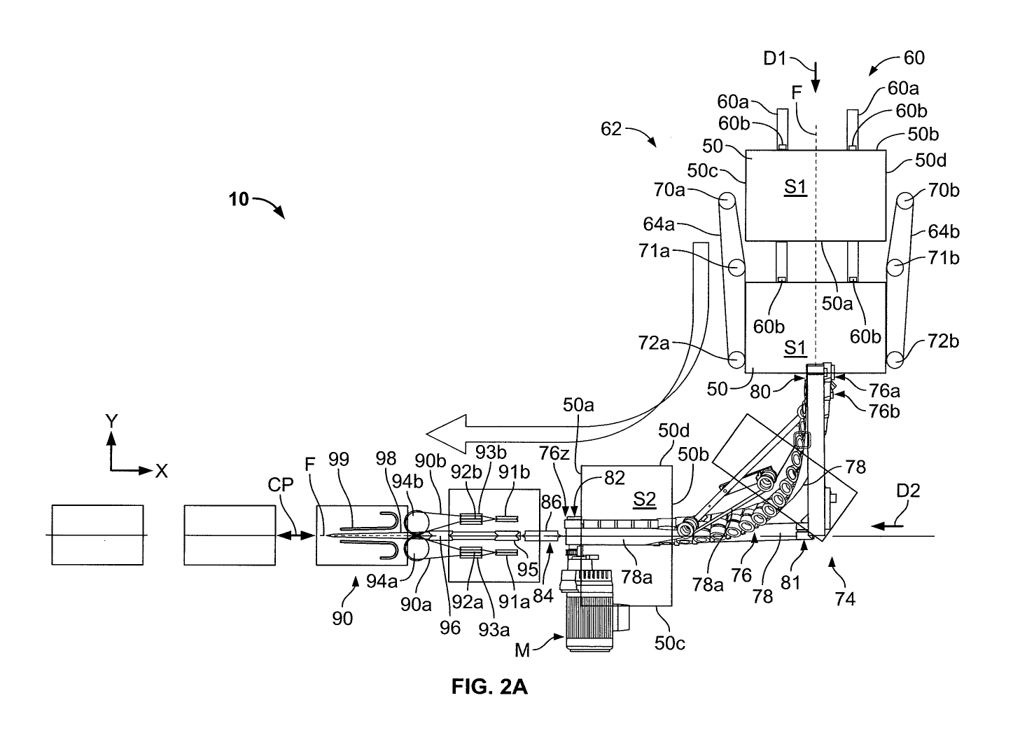

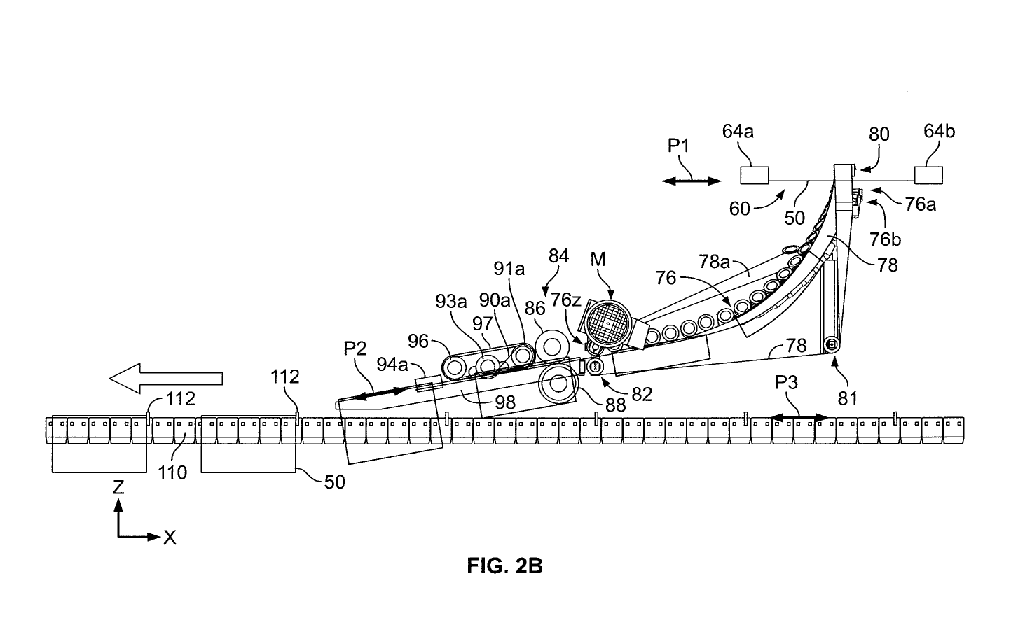

FIG. 1 schematically shows a plan view of a variable data sheet insertion device 20 according to an embodiment of the present invention included in a post-press line 100. The inclusion of insertion device 20 in post-press line 100 allows an operator of post-press line 100 to produce bound printed products including both standard printed sheets, which include data or content that is the same in all of the bound printed products, and varying printed sheets, which include data or content that is customized for one consumer or one group of consumers. For example, in post-press line 100, a plurality of standard printed signatures, in which all signatures of a group include the same data or content, are gathered on a gathering conveyor 110 (FIG. 2b). The standard printed signatures may be printed by conventional printing presses and may be fed onto conveyor 110 to form books using conventional feeders 22, 26 (which hold sheets that they fold into signatures before feeding to the conveyor) or hoppers 30 (which hold signatures that they feed the signatures to the conveyor). Each hopper 30 or feeder 22, 26 may include one group of pre-printed signatures (in the case of hopper 30) or sheets (in the case of a folder-type feeders 22, 26) to be included into bound printed product or book formed on post-press line 100, with each signature (sheet) in one group including the same data or content. As is known in the art, the hoppers/feeders in the post-press line can be selectively activated, so that at any given time, one, some, or all of the hoppers/feeders will be feeding signatures onto the gathering conveyor 110. Different feeder/hoppers typically hold different groups of preprinted signatures or sheets, although some feeders may hold the same group of preprinted signatures or sheets as other feeders, either to provide enhanced speed by operating in tandem with another feeder (each feeder in the tandem feeding every other book), or to correct a misfeed of another feeder. Accordingly, each bound printed product or book formed on post-press line 100 will typically include a plurality of standard pages that include the same standard data or content as the other bound printed products (i.e., all of the bound printed products may include one standard sheet from each activated feeder 22, 26 or hopper 30). In order to customize each printed product formed on post-press line 100, variable data sheet insertion device 20 is included in post-press line 100 to add a sheet including variable data into each printed product.

An unprinted, partially printed, or fully printed web may be unrolled at an unwinding station 12 and transported in a transport direction D1 through a single or dual-side printing station 14. Printing station 14 may include one or more printing units, with each printing unit printing on one or both sides of the web. Printing station 14 may be a digital printing press, for example an electrophotographic or ink jet printing press, and may print varying images on both sides of the web. In configurations in which the unrolled web is fully printed, the printing station can be omitted or be inactive. A controller 200, which may include a memory that stores information regarding the customized data or content to be printed for each sheet or group of sheets, may control printing station 14 to ensure that the proper data and content as desired on the web. After printing station 14, the printed web may then be transported in direction D1 through a cutting device 16, which in this embodiment is a sheeter, for cutting the printed web into successive printed sheets 50 (FIGS. 2a, 2b) having images printed on one or both sides thereof Because printing station 14 is capable of printing variable images on the web, each sheet may include customized data for each printed product produced on post-press line 100. In this embodiment, cutting device is configured or phased to create printed sheets 50 that are longer in width than in length (i.e., edges 50a, 50b are longer than edges 50c, 50d shown in FIG. 2a). However, square sheets or sheets longer in length than width can alternatively be provided as desired, either by adjusting the phasing, configuration, or design of cutting device. Printed sheets 50, with a first side S1 (FIG. 2a) facing upward and a second side S2 (FIG. 2a) facing downward, exit cutting device 16 traveling in direction D1 along a plane P1 (FIG. 2b). Printed sheets 50 are then introduced into post-press line 100 operating in a second direction D2 perpendicular to direction D1 and in a plane P3 (FIG. 2b), which is parallel to and below plane P1.

Variable data sheet insertion device 20 includes an alignment and transport apparatus 10 between cutting device 16 and post-press line 100 receiving printed sheets 50 (FIGS. 2a, 2b) traveling along plane P1 (FIG. 2b) in direction D1 and realigning printed sheets 50 for traveling along plane P2 (FIG. 2b) in direction D2. Controller 200, through wired or wireless connections, may control motors driving the components of insertion device 20 so sheets 50 are moved at a velocity that matches the operating velocity of post-press line 100. As alignment and transport apparatus 10 realigns each printed sheet 50, each printed sheet 50 is flipped over such that first side S1 (FIG. 2a) faces downward and second side S2 (FIG. 2a) faces upward. Alignment and transport apparatus 10 continuously conveys printed sheets 50 downstream while realigning printed sheets 50, then releases printed sheets 50 from plane P2 to deposit printed sheets 50 onto post-press line 100 operating along plane P3 (FIG. 2b) with second side S2 facing upward and first side S1 facing downward.

A plurality of hoppers 30, which may or may not include hopper loaders 32, may also be provided downstream of the exit end of alignment and transport apparatus 10 to deposit additional sheets or inserts for combination with printed sheets 50. Additional equipment, which may be used to further personalize printed products or detect and remove faulty products from post-press line 100, may be provided downstream of hoppers 30. For example, an air reject base, an encoder base, an ink jet base and one or more blow in card bases may be provided at an area 40. A stitching device 42 may be provided in post-press line 100 downstream of area 40 for stitching the individual products accumulated in each position on post-press line 100 together to form a bound product. The bound product may then be rotated 90 degrees and be transported away from post-press line 100 to a finishing area 44. Finishing area 44 may include a trimmer 46 for trimming the edges of each bound product, one or more ink jet printers 48 for adding standard or personalized information to the bound products, a delivery table 49, a shrinkwrapper 52 for packing the finished products and a delivery conveyor 54.

Components may also be provided upstream of alignment and transport apparatus 10. As an example, alignment and transport apparatus 10 may introduce sheets 50 into post-press line 100 downstream of one or more upstream card folder feeders 22 and an upstream zone air base 24. One or more downstream card folder feeders 26 and a downstream zone air base 28 may also be provided if desired downstream of where alignment and transport apparatus 10 deposits sheets 50 into post-press line 100.

FIG. 2a schematically shows a plan view of alignment and transport apparatus 10 and FIG. 2b schematically shows a side view of alignment and transport apparatus 10. Alignment and transport apparatus 10 includes a horizontally aligned conveyor 60 at an entrance or upstream end thereof receiving printed sheets 50 from cutting device 16 (FIG. 1). Conveyor 60 may include a plurality of tapes, belts or chains 60a for transporting printed sheets 50 horizontally away from cutting device 16. Conveyor 60 may also include a plurality of register pins 60b spaced on tapes, belts or chains 60a for longitudinally aligning printed products 50 as printed products 50 are transported by conveyor 60.

An adjustable lateral aligner 62 is provided with conveyor 60 to ensure alignment of printed sheets 50 as printed sheets 50 exit conveyor 60. Adjustable lateral aligner 62 may include vertically aligned belts 64a, 64b on opposite sides of conveyor 60, extending horizontally along conveyor 60 in direction D1. Beginning at the upstream ends of vertically aligned belts 64a, 64b, belts 64a, 64 converge toward one another until belts 64a, 64a are spaced from one another at a distance that is substantially equal to the width of printed products 50, such that belts 64a, 64b laterally align printed products 50 as printed products 50 are transported along conveyor 60. Belts 64a, 64b may be slid towards and away from one another by one or more actuators in response to directions from controller 200 (FIG. 1) so that printed sheets 50 are properly aligned for folding.

Although alternative arrangements for controlling belts 64a and 64b may be used, in an exemplary implementation, on a first side of conveyor 60, belt 64a travels around three rollers or pulleys 70a, 71a, 72a and on a second side of conveyor 60, belt 64b travels around three rollers or pulleys 70b, 71b, 72b. Pulleys 70a, 70b, which are positioned at an upstream end of conveyor 60, are spaced from each other at a distance that is greater than the width of printed sheets 50, while pulleys 72a, 72b, which are positioned at a downstream end of conveyor 60, are spaced from each other at a distance substantially equal to the width of printed sheets 50 and pulleys 71a, 71b, which are between pulleys 70a, 72a and 70b, 72b, respectively, are also spaced from each other at a distance substantially equal to the width of printed sheets 50. Pulleys 70a, 70b, 71a, 71b, 72a, 72b are aligned with respect to conveyor 60 such that a desired fold line F, i.e., where printed sheets 50 are to be folded, is correctly positioned with respect to the downstream elements of alignment and transport apparatus 10 such that each printed sheet 50 is accurately folded by a folding apparatus 90. As printed sheets 50 are transported by conveyor 60 and aligned by aligner 62, fold line F is positioned halfway in between the section of belt 64a between pulleys 71a, 72a and the section of belt 64b between pulleys 71b, 72b and parallel to direction D1. At least pulleys 71a, 71b, 72a, 72b and preferably also pulleys 70a, 70b are adjustably mounted with respect to conveyor 60 such that between print jobs, the width of adjustable lateral aligner 62 may be varied to accommodate sheets of greater or lesser width than printed sheets 50. In other words, pulleys 70a, 70b, 71a, 71b, 72a, 72b may be slidably mounted in a support structure such that pulleys 70a, 70b, 71a, 71b, 72a, 72b and corresponding belts 64a, 64b may be slid towards and away from one another by one or more actuators in response to directions from controller 200 (FIG. 1) so that printed sheets 50 are properly aligned for folding.

A twisting apparatus 74 is provided downstream of conveyor 60 and lateral aligner 62 for aligning printed sheets 50 in accordance with post-press line 100. At an input or upstream end thereof, twisting apparatus 74 receives printed sheets 50 having first sides SI facing upward and while transporting each printed sheet 50 downstream, twisting apparatus flips each sheet 50 such that as printed sheets 50 exit an output or downstream end of twisting apparatus 50, second side S2 faces upward. Twisting apparatus 74 is configured to rotate each printed sheet 50 ninety degrees in an X-Y plane and flip each printed sheet 50 over while constantly progressing each printed sheet 50 in the X, Y and Z directions to move each printed sheet 50 forward towards post-press line 100, with printed sheets entering twisting apparatus 74 traveling in direction D1 and exiting twisting apparatus traveling in direction D2. Each printed sheet 50 is flipped such that each printed sheet 50 enters into twisting apparatus 74 with an edge 50a leading and an edge 50b trailing, with an edge 50c being on the right and an edge 50d being on the left with respect to direction D1 that printed sheet 50 is traveling, and exits twisting apparatus with edge 50a leading and edge 50b trailing, but with edge 50c being on the left and edge 50d being on the right with respect to direction D2 that printed sheet 50 is traveling. Twisting apparatus 74 is also configured to constantly move printed sheet 50 downward in the Z-direction while constantly moving printed sheet 50 in the X-direction and the Y-direction. Therefore, twisting apparatus 74 flips over each printed sheet 50 while rotating each printed sheet 50 ninety degrees and constantly moving each printed 50 in three directions (X, Y and Z). Rollers 76 are supported and positioned in a frame or frame(s) arranged to provide the desired twisting path.

To reorient and transport printed sheets 50 in such a manner, twisting apparatus 74 is accordingly configured with an output or downstream end thereof being perpendicular and lower than an input or upstream end thereof Specifically, twisting apparatus 74 may include a plurality of freely rotating rollers 76 that form a spiraling plane defining a transport path of twisting apparatus 74 followed by continuous belts 78 and 78a. Rollers 76 are arranged as sets, with rollers 76 in a particular set sharing a common center axis. A first set of rollers 76a is positioned at the entrance of twisting apparatus 74 and is aligned so as to have a common center axis extending perpendicular to direction D1 and parallel to direction D2 and so top surfaces of rollers 76a are aligned with plane P1 on which printed sheets 50 enter twisting apparatus 74. A second set of rollers 76b adjacent to the set of rollers 76a, further down the transport path of twisting apparatus 74, is twisted in comparison to rollers 76a so as to have a center axis angled with respect to both directions D1, D2 (and the center axis of rollers 76a) and is positioned lower than rollers 76a and further in directions D1, D2. Angled as used herein defines an angle other than 0, 90 or 180 degrees. Sets of successive rollers 76 along the path of twisting apparatus 74 are further incrementally twisted, lowered and further in directions D1, D2 with respect to the preceding set of rollers 76 such that the last set of rollers 76z is positioned along a center axis parallel to direction D1 and perpendicular to direction D2 and is arranged further in both directions D1, D2 than all of the preceding sets of rollers 76 in the path of twisting apparatus 74.

It should be noted, that the last few sets of rollers 76 preceding rollers 76z may also have center axes positioned parallel to direction D1 and perpendicular to direction D2 and the first few sets of rollers 76 following rollers 76a may also have center axes positioned parallel to direction D2 and perpendicular to direction D1, so as to stabilize the transition from twisting apparatus 74 to the downstream components and the transition from conveyor 60 to twisting apparatus 74. In alternative embodiments, rollers 76 may be replaced by smaller rollers and two or more successive sets of rollers may have center axes that are parallel, such that for example each two sets of rollers are incrementally angled with respect to the preceding two sets. Printed sheets 50 follow along the spiraling plane formed by rollers 76, with each sheet 50 entering twisting apparatus 74 above rollers 76a and exiting twisting apparatus 74 below rollers 76z. Printed sheets 50 are progressed through the path of twisting apparatus 74 by continuous belt 78, which contacts first side S1 of each printed sheet 50 as belt 78a contacts second side S2. The successive twisting of sets of belt 78a and belt 78, flips printed sheets 50 over while rotating printed sheets 50 ninety degrees in the X-Y plane and downward in the Z-direction. Belt 78 is pressed snugly against belt 78a in order for twisting apparatus 74 to maintain positive control over printed sheets 50 throughout the path of twisting apparatus 74. Belt 78 is wrapped around and guided by at least pulleys 80, 81, 82, and belt 78a is wrapped around pulleys 76, 76a, 76z at least one of which is driven by a motor M. Pulley 80, which is located above rollers 76a at the entrance of twisting apparatus 74, has a center axis that is parallel to direction D2 and perpendicular to direction D1. Pulley 82, which is located below rollers 76z at the exit of twisting apparatus 74, has a center axis that is parallel to direction D1 and perpendicular to direction D2. Pulley 81, which is located between pulleys 80, 82, has a center axis that is parallel to direction D1 and perpendicular to direction D2.

As printed sheets 50 exit twisting apparatus 74, printed sheets 50 travel along horizontally angled plane P2, which is angled with respect to horizontally aligned plane P1, and along a vertically aligned center plane CP, with printed sheets 50 being transported so that folding line F of each sheet 50 essentially follows a line at which plane P2 and center plane CP intersect. Post-press line 100 also follows a path of center plane CP. In this embodiment, each printed sheet 50 may then enter a scoring apparatus 84 including a scoring wheel 86 and an opposing anvil wheel 88. Scoring wheel 86 includes a vertically aligned protrusion that interacts with a vertically aligned groove in anvil wheel 88 to score printed sheets 50. Both the protrusion of scoring wheel 86 and the groove in anvil wheel 88 are centered along center plane CP. Accordingly, as each printed sheet 50 passes between wheels 86, 88, each printed sheet 50 is scored along folding line F and transported downstream with folding line F in center plane CP. The scoring aids the subsequent folding by folding apparatus 90. In other embodiments, scoring apparatus 84 may be omitted.

Folding apparatus 90 is positioned downstream of scoring apparatus 84 and receives scored printed sheets 50 and folds sheets 50 along folding line F. Folding apparatus 90 includes a belt 90a supported by pulleys 91a, 92a, 93a and a fold finishing roller 94a and a belt 90b supported by pulleys 91b, 92b, 93b and a fold finishing roller 94b. Belts 90a, 90b are positioned on opposite sides of center plane CP and are angled towards center plane CP as belts 90a, 90b move downstream. Pulleys 91a, 92a, 93a, 91b, 92b, 93b are aligned to rotate about horizontally extending axes while rollers 94a, 94b are aligned to rotate about vertically extending axes. Belts 90a, 90b are respectively guided around pulleys 91a, 91b by vertically aligned grooves in pulleys 91a, 91b and then under pulleys 92a, 92b by vertically aligned grooves in pulleys 92a, 92b to horizontally aligned grooves in rollers 94a, 94b. Rollers 94a, 94b are positioned so that the section of belt 90a between pulley 92a and roller 94a and the section of belt 90b between pulley 92b and roller 94b are angled towards one another. Belts 90a, 90b extend around rollers 94a, 94b and are guided under pulleys 93a, 93b through vertical grooves in pulleys 93a, 93b back to pulleys 91a, 92b, respectively. Two center rollers 95, 96, each including a vertically aligned groove centered on center plane CP and rotating about a respective horizontal axis are provided between belts 90a, 90b to begin folding printed sheets 50. Center rollers 95, 96 may be driven by a single motor and may be coupled together by a belt 97. Center rollers 95, 96 may work in cooperation with a folding sword 98 that is arranged such that a folding edge thereof that extends into the grooves in center rollers 95, 96. The folding edge of folding sword 98 is aligned with plane P2 and center plane CP such that folding edge extends approximately along the line formed by the intersection of plane P2 and center plane CP. Folding sword 98 is positioned to extend from upstream center roller 95 past downstream center roller 96 and fold finishing rollers 94a, 94b. Fold finishing rollers 94a, 94b may be beveled at the bottoms thereof to allow folding sword 98 to pass between rollers 94a, 94b.

As each printed sheet 50 enters into folding apparatus 90, second side S2 of each printed sheet 50 contacts upstream center roller 95 and first side S1 of each printed sheet contacts folding sword 98 to begin folding each sheet 50 along fold line F. Center rollers 95, 96 moves sheet 50 along folding sword 98 and into contact with downstream center belts 90a, 90b. Belts 90a, 90b and fold finishing rollers 94a, 94b then finish the folding of printed sheet 50 and, with the help of guides 99, printed sheet 50 is released onto gathering conveyor 110 traveling in plane P3 below folding sword 98 and in direction D2. In this embodiment, gathering conveyor 110 is a continuously moving saddle back conveyor and includes a plurality of pushers or lugs 112 spaced thereon, with conveyor 110 moving such that each pusher 112 receives and aligns one printed sheet 50. It should be noted that although conveyor 110 is shown not carrying any sheets as conveyor 110 approaches insertion device 20, upstream of insertion device 20 along post-press line 100 feeders or hoppers may stack one or more sheets adjacent each pusher 112 and printed sheets 50 may be stacked on top of these sheets. Also, downstream of insertion device 20 along post-press line 100 feeders or hoppers may stack one or more sheets adjacent each pusher 112 on top of printed sheets 50. In another embodiment, conveyor 110 may be a conveyor of a perfect binder, in which case folder 90 may or may not be used.

In alternative embodiments, the method and apparatus may be used to properly feed and position unfolded sheets into collators. In these embodiments, scoring apparatus 84 and folding apparatus 90 may be omitted.

The embodiment described with respect to FIGS. 1, 2a, 2b relates to an apparatus and method that accurately maintains the longitudinal and lateral positional registration of a printed sheet relative to the receiving location while orienting, feeding and folding the printed sheet to a desired finished size at system operating speed. In order to accommodate sheets having a different width than printed sheets 50, belts 64(a) and 64(b) of adjustment of alignment and transport apparatus 10 can be moved independently to position the fold line F for subsequent scoring by scoring apparatus 84 and folding by folding apparatus 90. In the exemplary implementation discussed above, this can be accomplished by adjusting the positions of at least pulleys 71a, 71b, 72a, 72b, and possibly also pulleys 70a, 70b, to vary the spacing between belts 64a, 64b. This is due to the arrangement of twisting apparatus 74 and the further downstream components of alignment and transport apparatus 10—scoring apparatus 84 and folding apparatus 90—with respect to center plane CP.

The embodiment described with respect to FIGS. 1, 2a, 2b also advantageously allows printed sheets having variable data to be produced by an existing post-press line. For example, one or more variable data sheet insertion devices 20 may be retrofitted into an existing post-press line to add flexibility to the post-press line. Variable data sheet insertion devices 20 may be added into any position of a post-press line upstream of a stitcher or binder without greatly modifying or affecting the operation of any of the other components of the post-press line.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An alignment and transport apparatus comprising:
an input conveyor transporting successive sheets in a first plane in a first direction; and
a twisting apparatus defining a transport path for the successive sheets, the twisting apparatus being configured such that each of the sheets enters the transport path in the first plane and traveling in the first direction with a first side of each of the sheets facing upward, and such that each of the sheets exits the transport path in a second plane and traveling in a second direction with a second side of each of the sheets facing upward.

2. The alignment and transport apparatus recited in claim 1 wherein the first direction is perpendicular to the second direction.

3. The alignment and transport apparatus recited in claim 1 wherein the first plane is above the second plane such that the twisting apparatus transports the successive sheets downwardly.

4. The alignment and transport apparatus recited in claim 1 wherein the first plane is parallel to horizontal and the second plane is angled with respect to the first plane.

5. The alignment and transport apparatus recited in claim 1 further comprising a folding apparatus aligned along a center plane and positioned downstream of the twisting apparatus, the folding apparatus folding each of the sheets, the sheets being transported along the second plane as the sheets are folded by the folding apparatus.

6. The alignment and transport apparatus recited in claim 5 wherein the folding apparatus includes belts converging into the center plane and a stationary folding sword aligned with the second plane.

7. The alignment and transport apparatus recited in claim 6 wherein the folding apparatus further includes at least one center roller aligned above the folding sword upstream of where the belts converge into the center plane.

8. The alignment and transport apparatus recited in claim 5 wherein the folding apparatus transports the sheets along the second plane and folds the sheets at a folding line of the sheets that is aligned along the center plane.

9. The alignment and transport apparatus recited in claim 1 further comprising a conveyor downstream of the twisting apparatus traveling in the second direction along a third plane.

10. The alignment and transport apparatus recited in claim 1 further comprising aligning belts extending on opposite sides of the input conveyor.

11. The alignment and transport apparatus recited in claim 1 wherein the twisting apparatus includes a plurality of sets of rollers defining the transport path that are incrementally angled along the transport path.

12. The alignment and transport apparatus recited in claim 11 wherein the twisting apparatus includes continuous moving belts being guided along the transport path by the rollers, the sheets being received between the belts and being moved along the transport path by the belts.

13. A variable data sheet insertion device comprising:
a printing station printing varying images on a web;
a cutting device cutting the web into successive varying sheets; and
an alignment and transport apparatus downstream of the cutting device receiving the successive varying sheets and realigning the successive varying sheets, the alignment and transport apparatus receiving the successive varying sheets traveling in a first direction with a first side of each sheet facing upward and outputting the successive varying sheets in a second direction with a second side of each sheet facing upward.

14. A post-press processing apparatus producing printed products comprising:
the variable data sheet insertion device recited in claim 13; and
a post-press line moving additional sheets in the second direction, the alignment and transport apparatus introducing the successive varying sheets into the post-press line for combination with the additional sheets, the post-press line forming printed products each including one of the varying sheets and at least one of the additional sheets.

15. The variable data sheet insertion device of claim 13, wherein the alignment and transport apparatus includes
an input conveyor transporting successive sheets in a first plane in a first direction; and
a twisting apparatus defining a transport path for the successive sheets, the twisting apparatus being configured such that each of the sheets enters the transport path in the first plane and traveling in the first direction with the first side of each of the sheets facing upward, and such that each of the sheets exits the transport path in a second plane and traveling in a second direction with the second side of each of the sheets facing upward.

16. A method for aligning and transport printed products comprising:
receiving a printed product traveling along a first plane in a first direction at an input of a transport path, the printed product being aligned during the receiving such that a first side of the printed product faces upward and a first edge of the printed product is aligned perpendicular to the first direction;
continuously moving the printed product along the transport path such that the printed product is realigned; and
outputting the printed product from an end of the transport path along a second plane in a second direction, the printed product being aligned during the outputting such that a second side of the printed product faces upward and the first edge of the printed product is aligned perpendicular to the second direction.

17. The method recited in claim 16 wherein the first direction is perpendicular to the second direction.

18. The method recited in claim 16 wherein the second plane is below and angled with respect to the first plane.

19. The method recited in claim 16 wherein the transport path is formed by a plurality of sets of rollers that are incrementally angled along the transport path.

20. The method recited in claim 16 wherein a belt moves the printed product along the transport path.

21. The method recited in claim 16 further comprising transporting the printed product along the second plane and depositing the printed product on a conveyor moving along a third plane.
